(19) United States
(12) Patent Application Publication
(10) Pub. No.: US 2026/0010877 A1
(43) Pub. Date: Jan. 8, 2026

(54) FRAUD DETECTION TECHNIQUES

(71) Applicant: THE HUNTINGTON NATIONAL BANK, Columbus, OH (US)

(72) Inventor: Stephen Hageman, Columbus, OH (US)

(21) Appl. No.: 18/764,670

(22) Filed: Jul. 5, 2024

(51) Int. Cl. G06Q 20/04; G06N 3/0464; G06N 3/09; G06Q 20/40; G06V 30/14

(52) U.S. Cl. CPC G06Q 20/042; G06N 3/0464; G06N 3/09; G06Q 20/4016; G06V 30/1448

(57) ABSTRACT

Techniques are described herein for detecting fraudulent check transactions. A machine-learning model that has been trained to determine whether check data provided as input is indicative of fraud may be obtained. The machine-learning model may be trained with a supervised learning algorithm and a training data set that includes examples that include check-in-clearing data, at least one historical check transaction, and a label indicating whether the example is fraudulent or legitimate. Subsequently, check-in-clearing data may be received for a pending check transaction. One or more historical check transactions may be identified from account data corresponding to the pending check. The check-in-clearing data and the historical check transaction(s) may be provided to the model as input. One or more operations may be performed based on determining that the model's output indicates the pending check transaction is fraudulent.

### BACKGROUND

Check fraud may include any efforts to obtain money illegally using paper or digital checks. Some examples of check fraud include using a stolen check without authorization from the account holder, altering the amount of a legitimate check, and using a counterfeit check, to name a few. Conventional techniques for detecting a fraudulent check may include scanning the check with a ultraviolet scanner to see if the ink has been altered and/or manually inspecting the digital or physical check. Fraudulent checks may take weeks to be discovered, long after the fraudster has absconded with the money. Reducing the latency and/or increasing the case and accuracy of fraudulent check detection may reduce the negative impacts to both the account holder and financial institutions involved.

### BRIEF SUMMARY OF THE INVENTION

Techniques are provided fraudulent check detection. Various embodiments are described herein, including methods, systems, non-transitory computer-readable storage media storing programs, code, or instructions executable by one or more processors, and the like.

One embodiment is directed to a computer-implemented method for detecting a fraudulent check transaction. The method may comprise obtaining, by a computing device, a machine-learning model that has been trained to determine whether check data provided as input is indicative of fraud. In some embodiments, the machine-learning model is trained with a supervised learning algorithm and a training data set. A training data set example of the training data set may comprise corresponding check-in-clearing data, at least one historical check transaction, and a label indicating whether the training data set example is associated with fraud. The method may comprise receiving, by the computing device, check-in-clearing data corresponding to a pending check transaction. The method may comprise identifying, by the computing device from account data corresponding to the pending check transaction, a set of one or more historical check transactions. The method may comprise providing, by the computing device, the check-in-clearing data and the set of one or more historical check transactions to the machine-learning model as input data. The method may comprise determining, by the computing device, that the pending check transaction is fraudulent based at least in part on output received from the machine-learning model. The method may comprise performing, by the computing device, one or more operations based at least in part on determining that the pending check transaction is fraudulent.

In some embodiments, the one or more operations comprise at least one of: rejecting the pending check transaction, transmitting a notification, transmitting an electronic message, or presenting data indicating that the pending check transaction is fraudulent.

In some embodiments, the method comprises 1) generating, by the computing device, the training data set based at least in part on obtaining check-in-clearing data instances and historical check transactions corresponding to respective accounts associated with the check-in-clearing data instances and 2) training the machine-learning model with the supervised learning algorithm and the training data set.

In some embodiments, the training data set example further comprises consortium data, the consortium data being received from a corresponding computing device associated with a consortium, the consortium data indicating at least one entity that has been determined to be associated with past fraudulent activity.

In some embodiments, the corresponding check-in-clearing data comprises a first check image, the at least one historical customer check transaction comprises a second check image, and the method further comprises 1) identifying, from the first check image, a first handwriting example, 2) identifying, from the second check image, a second handwriting example, and 3) generating, by the computing device, a handwriting similarity value indicating a degree of handwriting similarity based at least in part on comparing the first handwriting example to the second handwriting example. In some embodiments, the training data set example further comprises the handwriting similarity value.

In some embodiments, the method further comprises 1) identifying a first handwriting example identified from a first image of a first check of the check-in-clearing data corresponding to the pending check transaction, 2) identifying a second handwriting example from a second image of a second check from the set of historical check transactions, and 3) generating, by the computing device, a handwriting similarity value indicating a degree of handwriting similarity between the first handwriting example and the second handwriting example. In some embodiments, the handwriting similarity value is provided as part of the input data to the machine-learning model.

In some embodiments, generating the handwriting similarity value comprises 1) generating, using a convolutional neural network, a first feature embedding of the first handwriting example, 2) generating, using the convolutional neural network, a second feature embedding of the second handwriting example, and 3) calculating the handwriting similarity value based at least in part on the first feature embedding and the second feature embedding.

At least one embodiment is directed to a system comprising one or more processors and one or more memories storing computer-executable instructions that, when executed by the one or more processors, cause the one or more processors to perform the method(s) disclosed herein.

At least one embodiment is directed to a computing device comprising one or more processors and one or more memories storing computer-executable instructions that, when executed by the one or more processors, cause the one or more processors to perform the method(s) disclosed herein.

At least one embodiment is directed to a non-transitory computer-readable storage medium storing computer-executable instructions that, when executed with one or more processors of a computing device, causes the one or more processors to perform the method(s) disclosed herein.

### BRIEF DESCRIPTION OF THE DRAWINGS

Various embodiments in accordance with the present disclosure will be described with reference to the drawings, in which:

FIG. 1 is an example flow for detecting fraudulent check transactions, in accordance with at least one embodiment;

FIG. 2 illustrates a flow for an example method for training a machine-learning model, in accordance with at least one embodiment;

FIG. 3 is a schematic diagram of an example check depicting a variety of check data attributes with which a fraudulent check transaction may be detected, in accordance with at least one embodiment;

FIG. 4 is a block diagram illustrating techniques for utilizing a neural network to detect check fraud, in accordance with at least one embodiment;

FIG. 5 is a block diagram illustrating an example system that is configured to detect check fraud, in accordance with at least one embodiment;

FIG. 6 is a schematic diagram of an example computer architecture for the detection system, including a plurality of modules that may perform functions in accordance with at least one embodiment; and

FIG. 7 is a block diagram illustrating an example method for detecting a fraudulent check transaction, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Techniques are provided for detecting fraudulent check transactions. Check fraud may come in a variety of forms such as forgery (when someone alters a check), paperhanging/check kiting (when the account holder fills out a check for an amount that their account does not have funds to cover), counterfeiting (when someone creates a fake check), chemically altering or washing a check (e.g., to erase the ink, allowing the fraudster to write new information on the check), using a stolen check, and post-dating. Conventional techniques may take weeks to discover the fraudulent check, long after the fraudster has absconded with their stolen money. Convention check fraud detection techniques may be manual or, if automated, may use limited data when attempting to detect check fraud.

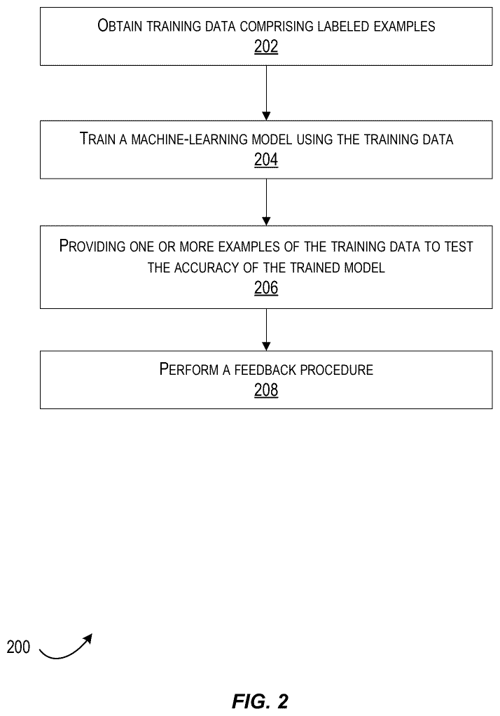

The disclosed techniques disclosed herein provide improvements to check fraud detection. These techniques may be utilized by the receiving bank (e.g., the bank with which the check was deposited), by the drawing bank (e.g., the payer's bank), or any suitable system utilized in the check clearing process. In some embodiments, such as when the drawing bank is performing the detection operations, account data for the account corresponding to the check may be utilized. In some embodiments, a neural network may be used to compare historical check images (or portions of check images) to an image of the pending check (or a portion of the image of the pending check) to identify differences with which fraud may be identified (e.g., utilizing handwriting comparisons, signature comparisons, and/or other comparisons to check historically written against that account). In some embodiments, any suitable combination of a check image, a corresponding feature embeddings, check-in-clearing data, and/or historical account data may be used as input with a machine-learning model to identify the pending check transaction as fraudulent or legitimate. In some embodiments, the machine-learning model may be trained using a supervised machine-learning algorithm and a labeled training data set. The training process may be discussed in greater detail with respect to FIG. 2. Utilizing the disclosed techniques, the fraudulent check may be discovered more quickly and with more accuracy than conventional systems allow.

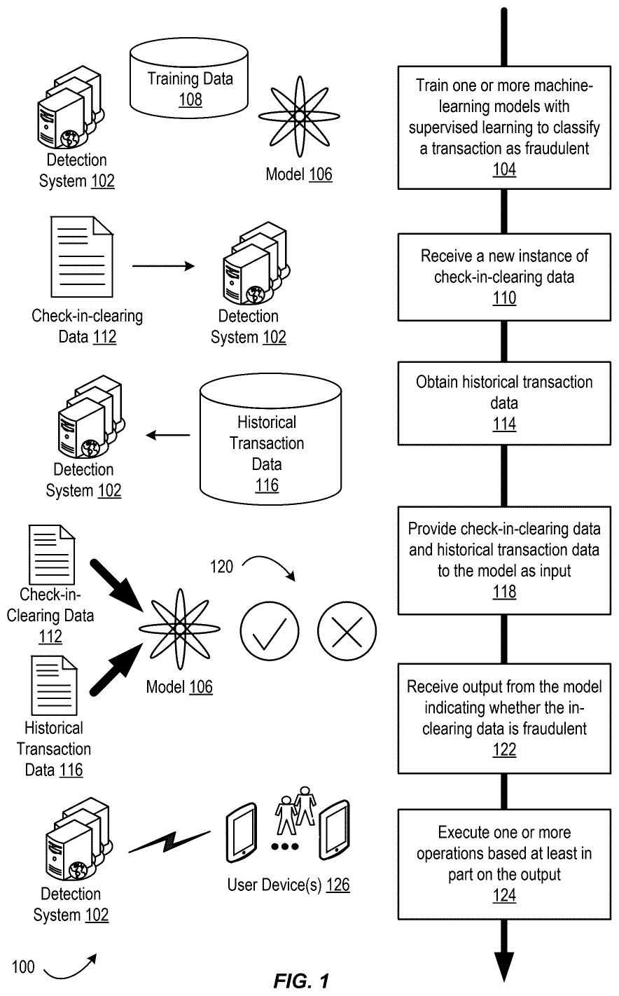

Moving on to FIG. 1 which illustrates an example flow 100 for detecting fraudulent check transactions, in accordance with at least one embodiment. The operations discussed in connection with FIG. 1 may be performed with detection system 102. In some embodiments, detection system 102 may be implemented by one or more computer(s), as a service, within an application, or the like. The operations discussed in connection with flow 100 may be performed in any suitable order. More or fewer operations than those depicted in FIG. 1 may be employed without diverting from this disclosure.

At 104, one or more machine-learning model(s) (e.g., model 106) may be trained according to any suitable supervised learning algorithm to determine whether a check transaction corresponding to the input data is fraudulent. For example, a detection system 102 (e.g., software, firmware, hardware, etc.) may access training data 108, a data store configured to store a training data set. The training data 108 may include any suitable number of fraudulent and/or legitimate check transaction examples. Each example may include any suitable combination of check-in-clearing data, historical check transaction and/or account data of the account corresponding to the pending transaction, and a label indicating whether the example is fraudulent or legitimate. Check-in-clearing data may include any suitable combination of check amount, serial/check number, the receiving bank's routing number, the deposit account number, the payer's account number, or any suitable information related to the check and/or the check transaction (e.g., one or more images of the pending check). In some examples, the training data 108 may include historically determined fraudulent and/or legitimate check transactions and/or manually labeled fraudulent and/or legitimate check transactions. By way of example, the training data 108 may include historical account data of the payer's account (e.g., one or more historical check images of checks previously drafted against the payer's account, previous transaction data of one or more historical account transactions, etc.). In some embodiments, training data 108 may include consortium data. “Consortium data” is intended to refer to any suitable data that is received from one or more computers of a consortium (e.g., a group of entities such as financial institutions) that indicates at least one entity (e.g., a person, a device, an account, etc.) that has been determined to be associated with past fraudulent activity.

The training data 108 may be used with any suitable supervised learning algorithm to train the model 106 to identify input data corresponding to a pending check transaction as either fraudulent or legitimate. A method for training the model 106 using training data 108 is discussed in more detail with respect to FIG. 2 and is not repeated here, for brevity.

At block 110, the detection system 102 may receive a new instance of check-in-clearing data (e.g., check-in-clearing data 112). As discussed above, the check-in-clearing data may include any suitable combination of a check amount, serial/check number, the receiving bank's routing number, the deposit account number, the payer's account number, historical account data of the payer's account (e.g., one or more historical account transactions), one or more images of the pending check, one or more historical check images of checks previously drafted against the payer's account, consortium data, or the like. In some embodiments, the check-in-clearing data may be received from a computing device participating in a check clearing process (e.g., the receiving bank, the bank at which the check was deposited). In other embodiments, the check-in-clearing data may be obtained by the same computing device that executes the operations of flow 100.

At 114, the detection system 102 may historical transaction data 116 (also referred to as “historical account data”) of the account corresponding to the pending check transaction. In some embodiments, the historical transaction data 116 may include any suitable data associated with the account such as the name of the payer, the address of the payer, any suitable data associated with one or more historical check transactions corresponding to the account (e.g., past check or other transaction amounts, past check or other payees, past check images, etc.), or the like.

At 118, any suitable combination of the check-in-clearing data 112 and/or the historical transaction data 116 may be provided to the model 106 as input data. In response to receiving the input data, the model 106 may generate output data 120 which may indicate that the pending check transaction is fraudulent or legitimate.

At 122, the detection system 102 may receive the output 120 from the model 106. In some embodiments, the output 120 may be a score or confidence value that indicates a likelihood or an amount of confidence that the check transaction is fraudulent or legitimate. By way of example, an output value of 0.82 may indicate an 82% confidence that the pending check transaction is fraudulent.

At 124, the detection engine 102 may execute one or more operations based at least in part on the output 120 received from the model 106. For example. If the model 106 determines that the pending check transaction is fraudulent, the detection system 102 may reject the pending transaction. Additionally, or alternatively, the detection system 102 may notify one or more user device(s) 126 (e.g., smartphones, computers, email(s), etc.) of the output 120. Notifying the one or more user device(s) may include, but should not be limited to, any suitable notification such as an email message, a short-message-service (SMS) notification, an automated phone call, or the like, indicating that a fraudulent check transaction was attempted, but was declined. In some embodiments, the detection system 102 may request confirmation of receipt of the notification, and/or request one or more user interaction(s) such as, but not limited to, rejecting the check transaction, allowing the check transaction to proceed, presenting an image of the check and confirming that the check is fraudulent or legitimate, or the like. In some embodiments, user confirmations(s) can be used by the detection system 102 to provide a feedback loop for retraining and/or updating the model 106.

FIG. 2 illustrates a flow for an example method 200 for training a machine-learning model (e.g., the model 106 of FIG. 1), in accordance with at least one embodiment. The method 200 may be performed by the detection system 102 of FIG. 1 and/or, at least partially, by a computing component separate and distinct from the detection system 102.

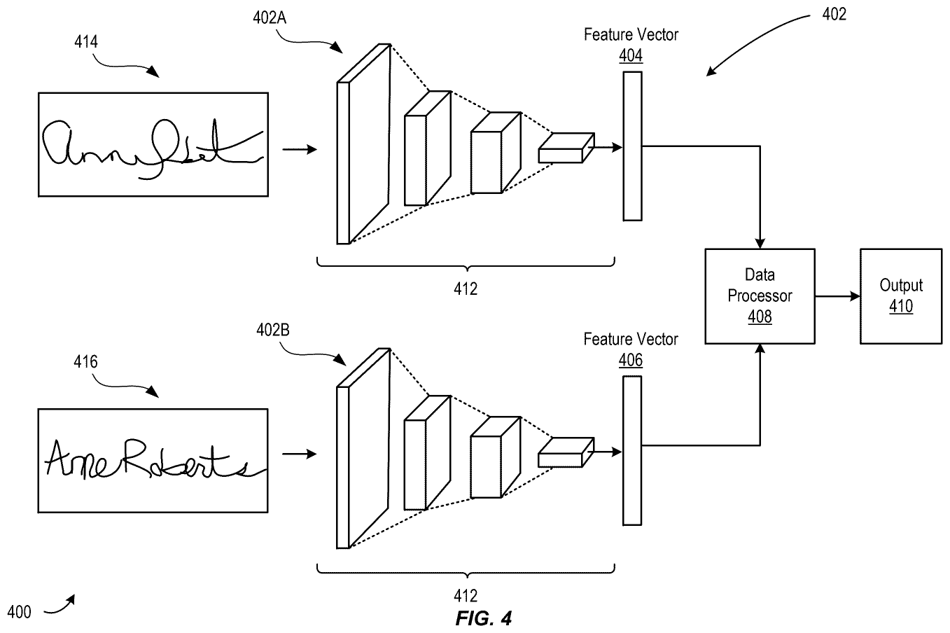

The method 200 may begin at 202, where training data comprising labeled examples may be obtained. The training data may include any suitable number of positive (e.g., fraudulent) or negative (e.g., legitimate) examples. Each example may include any suitable combination of check-in-clearing data corresponding to a particular check transaction, historical transaction data of the account corresponding to the particular check transaction, and a label indicating whether the example is fraudulent or legitimate. In some embodiments, the training data may include any suitable data related to the check and/or an image of the check. In some embodiments, the training data may include one or more outputs of another machine-learning model (e.g., the neural network 400 of FIG. 4) that individually indicate whether the image (or a portion of the image) of a check matches one or more images of historical checks corresponding to the same payer account.

At 204, the machine-learning model (e.g., the model 106) may be trained using the training data set and any suitable supervised machine-learning algorithm. A supervised machine-learning algorithm may learn patterns and relationships from the labeled training data set. As the training data is processed, a function is built that maps new input data to expected output values. The model may be trained until it can detect these patterns/relationships between input data and output labels, such that it can yield accurate labeling results when presented with new inputs. Example supervised machine-learning algorithms may include, but are not limited to, linear regression (an algorithm used to find a linear relationship between a dependent variable and one or more independent variables), logistic regression (an algorithm used to predict a binary outcome based on one or more independent variables), support vector machines (an algorithm used to find a best line or hyperplane that separates data points in a data set), decision trees (an algorithm that is used to create a model of decisions based on data), Naive Bayes (an algorithm used to predict the probability of an event based on prior knowledge), K-Nearest Neighbors (an algorithm used to find the K nearest neighbors of a data point), neural networks (an algorithm used to create a model that can learn and make predictions), random forests (an algorithm used to create a model that can learn and make predictions), and the like. In some embodiments, only a portion (e.g., 80%, 90%, etc.) of the training data set may be used to train the machine-learning model.

At 206, any suitable portion of the training data set (e.g., 20%, 10%) may be utilized to test the accuracy of the machine-learning model. In some embodiments, one or more training data set examples may be provided to the trained model to produce one or more outputs. These outputs may include any suitable combination of a label (e.g., “fraudulent” or “legitimate”) or a value (e.g., true, false, etc.). In some embodiments, the value may be a score or confidence value indicating a confidence that the example is fraudulent or legitimate. The output may be compared to the labels already known from the training data set for these examples to calculate how accurate the model is at correctly identifying an example check transaction as fraudulent or legitimate. In some embodiments, the machine-learning model may be trained but not utilized until the accuracy identified for the model breaches a predefined threshold (e.g., 80% accurate, 90% accurate, etc.).

At 208, a feedback procedure may be performed. By way of example, as the trained machine-learning model is utilized for subsequent inputs, the subsequent output generated by the model may be added to corresponding input and used to retrain and/or update the machine-learning model. In some embodiments, the example may not be used to retrain or update the model until the output is verified as part of the feedback procedure. By way of example, the feedback procedure may include presenting any suitable portion of an instance of input data and the output generated by the machine-learning model to a user via a user interface. The user may utilize the interface to indicate whether the output produced by the machine-learning model is correct for the given example. The input provided during the feedback procedure, either indicating the output was accurate or inaccurate, can be added to the training data and/or used to retrain and/or update the machine-learning model at any suitable time.

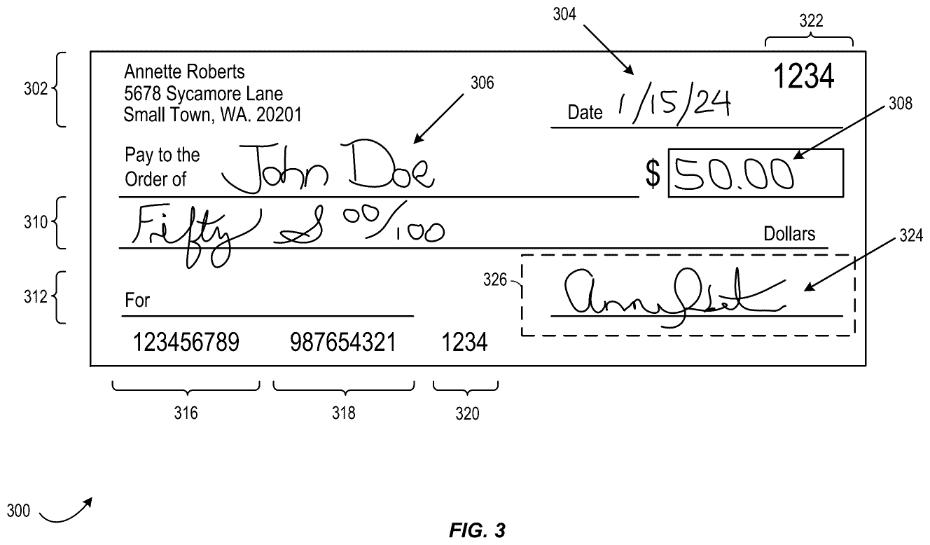

FIG. 3 is a schematic diagram of an example check 300 depicting a variety of check data attributes with which a fraudulent check transaction may be detected, in accordance with at least one embodiment. Check 300 may include payer information 302. Payer information may include any suitable combination of a first name, a middle name, a last name, an address, an identification number (e.g., a driver's license number) of the payer. Check 300 may include date information 304 which may be in any suitable format and handwritten. Check 300 may include Payee information 306 which may be handwritten and may identify a payee of the check 300. Check 300 may include amount 308 which may be handwritten in numeric format. Check 300 may include amount data 310 which may be handwritten and may represent the amount 308 in a different format than the one used for amount 308. For example, the amount data 310 may include one or more words and/or symbols that represent the amount 308. Check 300 may include description 312 which may include any suitable number of words and/or symbols that represent an annotation indicating a reason for the check. Check 300 may include routing number 316 (indicating a routing number of the financial institution that will pay the corresponding amount, if the check 300 is honored), account number 318 (indicating an account number associated with the payer), and a check serial number as depicted at 320 and again at 322. Check 300 may include signature 324 which may be handwritten.

In some embodiments, any suitable portion of the data depicted in FIG. 3 may be included in the check-in-clearing data 112 of FIG. 1. In some embodiments, any suitable image of the check 300 (or an image of a portion of the check 300) may be used in the manner described in connection with FIG. 4, to determine whether the image matches images of historical checks corresponding to the same account (e.g., an account corresponding to account number 318). As a non-limiting example, the area 326 of an image of check 300 (e.g., a pending check) may be used to compare to similar areas of historical checks of the same account to determine whether the signature 324 matches signatures provided on the historical checks. This is merely one example, any suitable area of an image of check 300 may be used to compare to similar areas of historical checks to determine whether the handwriting and/or language usage of a pending check matches those used for historical checks. As another non-limiting example, an area corresponding to the date information 304 may be used to determine whether the format and/or handwriting provided in date information 304 of an image of a pending check matches the date information of historical checks with respect to format and/or handwriting. Similarly, an area of an image of check 300 which depicts amount 308 may be used to determine whether the handwriting of the image of check 300 (e.g., a pending check) matches the handwriting used in amounts written on historical checks. Any suitable combination of the information depicted in FIG. 3 may be obtained (e.g., from a pending check, from a historical check, etc.) and used as input in the model 106 of FIG. 1 to determine whether a pending check transaction is fraudulent. In some embodiments, any area obtained from an image of check 300 (e.g., a pending check or a historical check) may be utilized as input to the neural network 400 discussed below to determine whether the handwriting, format, and/or language used in the image/area of the check 300 matches the handwriting, format, and/or language used in corresponding areas/images of one or more historical checks.

FIG. 4 is a block diagram illustrating techniques for utilizing a neural network (e.g., a neural network 400 comprising neural network 402A and neural network 402B) to detect check fraud, in accordance with at least one embodiment. In some embodiments, neural network 402A and neural network 402B may be instances of the same neural network, the outputs of which (e.g., feature vector 404 and feature vector 406) may be provided to data processor 408 to produce output 410. Neural networks 402A and 402B (collectively referred to as “neural networks 402) may each be an example of a convolutional neural network including any suitable number of layers 412. Convolutional neural networks are a class of deep neural networks that may be used to identify patterns in images, natural language processing, signal processing and the like. Layers 412 may include any suitable convolutional layer (e.g., configured to detect certain features of the input based on one or more filters, a layer that performs a convolution operation to input and passes the result to the next layer), rectified linear unit layers (e.g., configured to remove unwanted numbers such as negative numbers), pooling layers (e.g., layers that take a larger input and distill the input to a smaller form), and flattening layers (e.g., a layer configured to convert two-dimensional arrays from pooled features into a single, long continuous linear vector).

Neural network 402A may be configured to generate feature vector 404 from input 414 by passing input 414 incrementally through layers 412. In some embodiments, input 414 may be a signature of a check or any suitable portion of a check image. In some embodiments, input 414 may be a signature or check portion of a historical check corresponding to a particular account.

Neural network 402B may be configured to generate feature vector 406 from input 416 by passing input 416 incrementally through layers 412. In some embodiments, input 416 may be a signature of a check or any suitable portion of a check image. In some embodiments, input 416 may be a signature or check portion of a pending check transaction corresponding to the same account as the account to which input 414 corresponds.

Data processor 408 may be an example of a transformer. In some embodiments, data processor 408 may be configured with any suitable number of additional layers such as flattening layers (e.g., a layer configured to convert two-dimensional arrays from pooled features into a single, long continuous linear vector), fully connected layers (e.g., layers in which every input of a vector generated by one or more previous layers is connected to a corresponding portion of an output vector), and soft-max layers (e.g., a layer configured to turn values of an output vector to values that, when summed together, add up to 1 or a predefined maximum value). Data processor 408 may be configured to compare feature vector 404 to feature vector 406 based at least in part on any suitable similarity calculation technique. By way of example, a cosine similarity may be calculated using feature vector 404 and feature vector 406 to determine a degree of similarity between the two. The data processor 408 may provide the result of the similarity calculation as output 410. The output 410 may be used to determine whether the inputs 414 and 416 match. By way of example, the output 410 may be a number between 0 and 1, where the closer the number is to one, the stronger the confidence that the inputs match, whereas the closer the number is to zero, the stronger the confidence is that the inputs do not match. In some embodiments, the inputs 414 and 416 may be identified as matching only when the output 410 breaches a predefined threshold (e.g., 0.8, 0.9, etc.).

Although not depicted, neural networks 402 may include weights corresponding to each portion of a fully connected layer. These weights express connection strengths between each value and a corresponding category or classification (e.g., output 410 indicating a match or mismatch). Additionally, the neural networks 402 may be configured with hyperparameters (not depicted) which may be predefined and user configurable. These hyperparameters may identify how many features are to be utilized for each convolutional layer, what window size or stride is used for each pooling layer, a number of hidden neurons to be used for each fully connected layer, or the like.

In some embodiments, neural networks 402 may be initialized with random or predefined weights. Through a training process, the neural networks 400 may be trained to identify matches between images provided as input (e.g., any suitable portion of respective check images) based at least in part on a training data set (not depicted) for which inputs (e.g., respective check images) and outputs (indicating a match or mismatch between the inputs) is known. An input example of a training data set (e.g., comprising two images of any suitable portion of a check) may be processed by the neural network 400 (e.g., via neural networks 402), the resulting feature vectors may then be processed by the data processor, and the output of which may be compared to the known label (e.g., match/mismatch) or value (e.g., 0.95 indicating a match, 0.23 indicating a mismatch, etc.) for the example. Any error found between the generated output and the known label/value may be used to modify the weights of the neural networks 402. The process may be repeated any suitable number of times until error between the output produced by the neural network 400 is within a threshold of accuracy to known values. By way of example only, the neural network 400 may be trained and weights adjusted until output produced by the neural network 400 is within a threshold error rate (e.g., 95% accuracy).

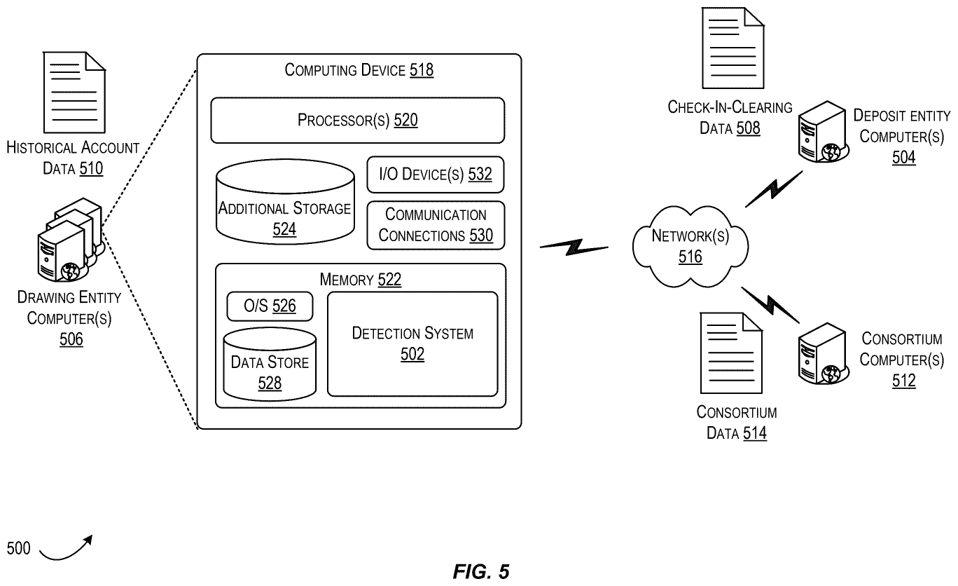

FIG. 5 is a block diagram illustrating an example system 500 including a detection system 502 (an example of the detection system 102 of FIG. 1), in accordance with at least one embodiment. System 500 may be configured to perform a clearing and settling process for clearing and settling check transaction between two entities such as a deposit entity (e.g., a bank at which a pending check was deposited) and a drawing entity (e.g., a bank corresponding to an account from which the funds are paid if the check is honored). Deposit entity computer(s) 504 may represent one or more computing devices corresponding to a deposit entity. Drawing entity computer(s) 506 may represent one or more computing device(s) corresponding to a drawing entity. While the detection system 502 is shown in FIG. 5 as being executed by the drawing entity computer(s) 506, it should be appreciated that the detection system 502 (or any suitable portion of the functionality of the detection system 502) may additionally, or alternatively, be executed by the deposit entity computer(s) 504.

In some embodiments, deposit entity computer(s) 504 may be configured to generate check-in-clearing data 508, an example of the check-in-clearing data 112 of FIG. 1. Check-in-clearing data may include any suitable combination of check amount, serial/check number, the receiving bank's routing number, the deposit account number, the payer's account number, or any suitable information related to the check and/or the check transaction (e.g., one or more images of the pending check).

In some embodiments, drawing entity computer(s) 506 may be configured to generate/obtain historical account data 510. Historical account data 510 may include account data of the payer's account (e.g., one or more historical check images of checks previously drafted against the payer's account, previous transaction data of one or more historical account transactions, etc.). In some embodiments, historical account data 510 may include any suitable number of output(s) provided by neural network 400 of FIG. 4. These outputs may individually indicate whether a check image (or portion of a check image) obtained from check-in-clearing data 508 was identified as matching one or more check images obtained from historical check transactions corresponding to the payer's account. In some embodiments, any suitable number of these outputs may be combined into a value that indicates a percentage of historical check images that were deemed to match the check image or portion of the check image obtained from check-in-clearing data 508.

In some embodiments, consortium computer(s) 512 may be configured to generated consortium data 514. “Consortium data” is intended to refer to any suitable data that indicates at least one entity (e.g., a person, a device, an account, etc.) that has been determined to be associated with past fraudulent activity.

In some embodiments, the deposit entity computer(s) 504, the drawing entity computer(s) 506, and the consortium computer(s) 512 may be configured to communicate via network 516. Network 516 may include any suitable combination of many different types of networks, such as cable networks, the Internet, wireless networks, cellular networks, and other private and/or public networks.

The deposit entity computer(s) 504, the drawing entity computer(s) 506, and the consortium computer(s) 512 may each be an example of the computing device 518. In some embodiments, the computing device 518 may include one or more processors (e.g., processor(s) 520). The processor(s) 520 may be implemented in hardware, computer-executable instructions, firmware, or combinations thereof. Computer-executable instruction or firmware implementations of the processor(s) 520 may include computer-executable or machine-executable instructions written in any suitable programming language.

Computing device 518 may include memory 522. The memory 522 may store computer-executable instructions that are loadable and executable by the processor(s) 520, as well as data generated during the execution of these programs. The memory 522 may be volatile (such as RAM) and/or non-volatile (such as ROM, flash memory, etc.). The computing device 518 may include additional storage (e.g., storage 524), which may include removable storage and/or non-removable storage. Storage 524 may include, but is not limited to, magnetic storage, optical disks and/or tape storage. The disk drives and their associated computer-readable media may provide non-volatile storage of computer-readable instructions, data structures, program modules, and other data for the computing devices.

The memory 522 and/or storage 524 may be examples of non-transitory computer-readable storage media. Computer-readable storage media may include volatile, or non-volatile, removable, or non-removable media implemented in any method or technology for storage of information such as computer-readable instructions, data structures, program modules, or other data. Memory 522 and/or additional storage 524 may include, but are not limited to, any suitable combination of PRAM, SRAM, DRAM, RAM, ROM, EEPROM, flash memory or other memory technology, CD-ROM, DVD, magnetic tape, magnetic disk storage or other magnetic storage devices, or any other medium which can be used to store desired information, and which can be accessed by the computing device 518. Computer-readable media may include computer-readable instructions, program modules, or other data transmitted within a data signal, such as a carrier wave, or other transmission. However, as used herein, computer-readable storage media does not include computer-readable communication media.

The memory 522 may include an operating system 526 and one or more data stores 528, and/or one or more application programs, modules, or services. The computing device may also contain communications connection(s) 530 that allow the computing device 518 to communicate with a stored database, another computing device, a server, user terminals and/or other devices (e.g., via one or more networks, not depicted). The computing device may include I/O device(s) 532, such as a keyboard, a mouse, a pen, a voice input device, a touch input device, a display, speakers, a printer, etc.

In some embodiments, the memory 522 may store instructions that, when executed by processor(s) 520 implement the functionality described herein with respect to the detection system 502 (e.g., the detection system 102 of FIG. 1).

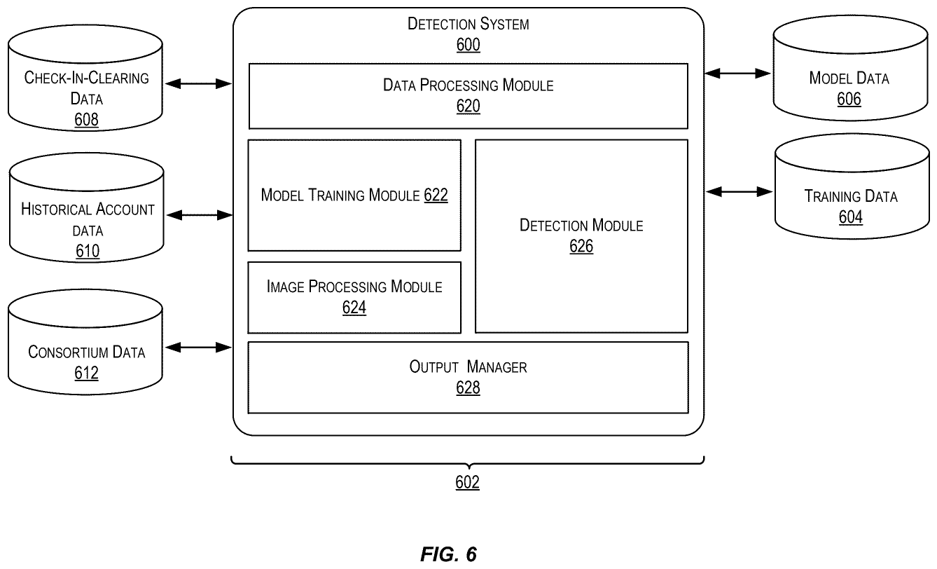

FIG. 6 is a schematic diagram of an example computer architecture for the detection system 600, including a plurality of modules that may perform functions in accordance with at least one embodiment. Detection engine 600 may be executed by the deposit entity computer(s) 504 and/or the drawing entity computer(s) 506 of FIG. 5. The modules 602 may be software modules, hardware modules, or a combination thereof. If the modules are software modules, the modules can be embodied on a computer readable medium and processed by a processor in any of the computer systems described herein. It should be noted that any module or data store described herein, may be, in some embodiments, be a service responsible for providing functionality corresponding to the module described below. The modules 602 may be execute as part of the detection system 600, or the modules 602 may exist as separate modules or services external to the detection system 600. In some embodiments, the modules 602 may be executed by the same or different computing devices, as a service, as an application, or the like.

In the embodiment shown in the FIG. 6, data stores such as those labeled in FIG. 6 as training data 604, model data 606, check-in-clearing data 608, historical account data 610, and consortium data 612 are shown, although data can be maintained, derived, or otherwise accessed from various data stores, either remote or local to the detection system 600, to achieve the functions described herein. The detection system 600, as shown in FIG. 6, includes various modules such as a data processing module 620, model training module 622, image processing module 624, detection module 626, and output manager 628. Some functions of the modules 620, 622, 624, 626, and 628 are described below. However, for the benefit of the reader, a brief, non-limiting description of each of the modules is provided in the following paragraphs.

Data processing module 620 may receive any suitable data (e.g., check-in-clearing data 508, consortium data 514, historical account data 510 of FIG. 5, etc.) from one or more networks (e.g., e.g., network(s) 516, an example of the Internet, wide area networks “WAN”, local area networks “LAN”, etc.). The data processing module 520 may be configured to store any suitable received data in a corresponding data store. By way of example, data processing module 620 may be configured to receive check-in-clearing data (e.g., check-in-clearing data 508) and store such data in check-in-clearing data 608, a data store configured to store such information. As another example, data processing module 620 may be configured to receive consortium data (e.g., consortium data 514) and store such data in consortium data 612, a data store configured to store such information. In some embodiments, data processing module 620 may receive and store historical account data (e.g., historical account data 510 corresponding to the payer's account) in historical account data 610, a data store configured to store such information, or the data processing module 620 may be configured to access historical account data 610 which may be managed by a separate system (e.g., a system associated with the payer's financial institution). Data processing module 620 may be configured to invoke the functionality of any other module of modules 602 based at least in part on any suitable condition or trigger.

Model training module 622 may include any suitable number of programs, algorithms, computer readable instructions, that, when executed, train a machine-learning model (e.g., the detection model 106 of FIG. 1, the neural network 400 of FIG. 4, etc.). In some embodiments, the machine-learning model may be trained utilizing method 200 of FIG. 2 or the training process described in connection with FIG. 4 to train the neural network 400. The model training module 622 may retrieve a training data set from training data 604 (e.g., training set 108 of FIG. 1), a data store configured to store such information. In some embodiments, the model training module 622 may generate a training data set from historical check-in-clearing data and historical account data of corresponding to any suitable number of historical check transactions from any suitable number of accounts. This training data may be labeled by the system as legitimate examples and/or at least some portion of the training data examples may be manually labeled (e.g., via user input). In some embodiments, the model training module 622 may utilize historical check transactions and historical account data as input to the image processing module 620 in order to obtain images (e.g., an image obtained from an instance of check-in-clearing data and one or more images of historical checks of an account corresponding to the check-in-clearing data) and/or one or more indications that the an image obtained from the historical check-in-clearing data matches or mismatches a corresponding image obtained from a historical check image associated with the same account. In some embodiments, image processing module 620 may provide the images and/or a combined value indicating how often (e.g., via a percentage value) the image obtained from an instance of check-in-clearing data matched one or more historical check transactions of a corresponding account. Any suitable data obtained from the image processing module 620 may be included in a training data example generated by the model training module 622.

The model training module 622 may utilize one or more relevant algorithms for supervised training to train one or more models with the training data (e.g., detection model 106, neural network 400, etc.). Additionally, the model training module 622 may function to periodically check the training data 604 for updated training data with which the model training module 622 may retrain or update any suitable model (e.g., detection model 106, neural network 400, etc.). The model training module 512 may be configured to store any suitable data corresponding to the trained model within model data 606, a data store configured to store such information.

Image processing module 624 may be configured to compare a check image (or a portion of a check image such as a check signature, a check payee line, etc.) to one or more historical check images (or portion of said images). The image processing module 624 may be configured to utilize neural network 400 of FIG. 4 to compare the check image or portion of the check image of a pending check transaction (e.g., a check image or portion of a check image obtained from check-in-clearing data 608 or received from data processing module 620) to one or more historical check images (or portion of historical check images). In some embodiments, the image processing module 624 may be configured to generate a combined output that indicates (e.g., via a percentage or the like) how often the check image or portion of the check image of the pending check transaction matched historical check images or portions of check images. By way of example, the image processing module 624 may compare any suitable data discussed in connection with FIG. 3 that is obtained from an image of the pending check, to one or more instances of that same data obtained from corresponding images of historical check transactions. In some embodiments, the combined output may be weighted such that matches between the pending check image and check images of more recent transactions are weighed more heavily than those of older transactions. In some embodiments, image processing module 624 may store the output(s) and/or combined output within check-in-clearing data 608 or may provide the output(s)/combined output to detection module 626 directly (or via data processing 620).

In some embodiments, the image processing module 624 may be used to determine a match between an image/portion of an image of a pending check and an image/portion of an image of a historical check. The input data and output data corresponding to this determination may be stored as a new training data example in training data 604. The new training data example may be used by the model training module 622 at any suitable time to train a new model and/or retrain or update a model (e.g., the neural network 400) stored in model data 606. Detection module 626 may obtain the detection model (e.g., detection model 106 of FIG. 1) from model data 606. The detection module 626 obtain any suitable combination of check-in-clearing data 608 (which may include the output(s)/combined output generated by image processing module 624), historical account data 610, and/or consortium data 612. The detection module 626 may be configured to provide any suitable combination of this data as input to the detection model and may receive output from the model indicating a likelihood that the corresponding pending check transaction is fraudulent or legitimate. In some embodiments, the detection module 626 may be configured to communicate with output manager 628 based at least in part on the output received from the model.

In some embodiments, the detection module 626 may be used to validate the model (e.g., the detection model 106, the neural network 400). By way of example, training data from training data 604 may be provided as input to the model and the corresponding output may be used to perform the feedback procedure discussed in connection with FIG. 2 to confirm that the output provided by the model is accurate or inaccurate.

In some embodiments, the detection module 626 may be used to determine whether a pending check transaction is fraudulent or legitimate. The input data and output data corresponding to this determination may be stored as a new training data example in training data 604. The new training data example may be used by the model training module 622 at any suitable time to train a new model and/or retrain or update a model (e.g., the detection model 106) stored in model data store 606.

In some embodiments, detection module 626 any suitable combination of the input data provided to a model or the output data generated by the model to the output manager 628. The functionality performed with respect to output manager 628 may include aggregating data obtained from any of the modules 620-626 and/or from data stores 604-612. In some embodiments, the output manager 628 may be configured to transmit a notification to one or more user device(s) (e.g., user device(s) 126 of FIG. 1) that indicates that the detection model has determined that a pending check is fraudulent and/or legitimate. In some embodiments, the notification may include any suitable data obtained from any of the modules 620-626 and/or from data stores 604-612. By way of example, output manager 628 may be configured to present an image of a pending check that has been determined by the detection module 626 as likely being fraudulent or legitimate to a user via user device(s) 126. In some embodiments, the output manager 628 may be configured to seek confirmation from the user that the check is fraudulent or legitimate. The output manager 628 may be configured to allow or reject the pending check transaction based at least in part on any suitable data obtained from the modules 620-626 or any suitable data obtained from data stores 608-612 which pertains to the pending check transaction. In some embodiments, allowing or rejecting the pending check transaction may further depend on user input solicited via user device(s) 126 as described above.

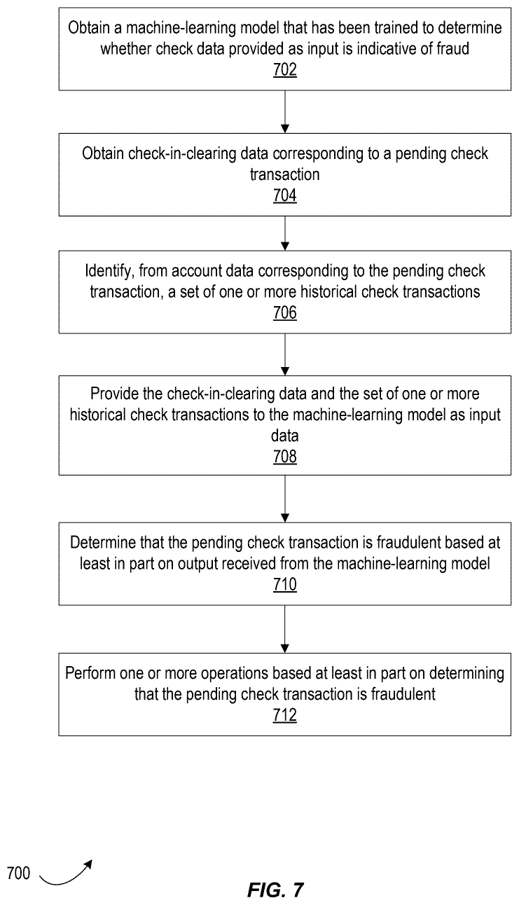

FIG. 7 is a block diagram illustrating an example method 700 for detecting a fraudulent check transaction, in accordance with at least one embodiment. A non-transitory computer-readable storage medium may store computer-executable instructions that, when executed by at least one processor, cause at least one computer to perform instructions comprising the operations of the method 700. It should be appreciated that the operations of the method 700 may be performed in any suitable order, not necessarily the order depicted in FIG. 7. Further, the method 700 may include additional, or fewer operations than those depicted in FIG. 7. The operations of method 700 may be performed by any suitable portion of the detection system 600 of FIG. 6 (an example of the detection system 102 of FIG. 1) which may include one or more computing devices such as computing device 518 of FIG. 5.

The method 700 may begin at 702, where a machine-learning model (e.g., model 106 of FIG. 1) that has been trained to determine whether check data provided as input is indicative of fraud may be obtained (e.g., by the detection module 622 of FIG. 6). In some embodiments, check data may include any suitable combination of the check-in-clearing data 508 of FIG. 5, the historical account data 510 of FIG. 5, the consortium data 544 of FIG. 5, or any suitable data generated by the image processing module 624 of FIG. 6. In some embodiments, the machine-learning model may be trained with a supervised learning algorithm and a training data set. The training data set may comprise a training data set example that includes check-in-clearing data, at least one historical check transaction (or an output generated by the image processing module 624 based at least in part on at least one historical check transaction), and a label indicating whether the training data set example is associated with fraud.

At 704, check-in-clearing data corresponding to a pending check transaction may be received (e.g., by the data processing module 620 of FIG. 6, from the deposit entity computer(s) 504 of FIG. 5). Check-in-clearing data may include any suitable combination of check amount, serial/check number, the receiving bank's routing number, the deposit account number, the payer's account number, or any suitable information related to the check and/or the check transaction (e.g., one or more images of the pending check).

At 706, a set of one or more historical check transactions may be identified by the computing device (e.g., by the data processing module 620 of FIG. 6) from account data corresponding to the pending check transaction. In some embodiments, the set of historical check transactions may correspond to a predefined number of the most recent check transactions corresponding to the account, a set of check transactions that historically occurred within a threshold time period (e.g., the last 30 days, the last 6 months, the last year, etc.), or any suitable number of check transactions. Additionally, or alternatively, any suitable number of other debit transactions associated with the account (e.g., the payer's account) may be identified (e.g., a predefined number of recent debit transactions, debit transactions occurring within a threshold time period such as the last month, the last year, or the like, and/or any suitable number of debit transaction).

At 708, the check-in-clearing data received at 704 and any portion of the transactions identified at 706 may be provided to the machine-learning model as input data.

At 710, it may be determined (e.g., by the detection module 626) that the pending check transaction is fraudulent based at least in part on output received from the machine-learning model.

At 712, one or more operations may be performed (e.g., by the output manager 628) based at least in part on determining that the pending check transaction is fraudulent. By way of example, the pending check transaction may be declined. As another example, any suitable data related to the pending check transaction (e.g., check-in-clearing data) may be presented at a user device to solicit confirmation as to whether the pending check transaction is fraudulent. If confirmed, the pending check transaction may be declined.

The various embodiments further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random-access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Where terms are used without explicit definition as recited herein, it is understood that the ordinary meaning of the word is intended, unless a term carries a special meaning in the field of anomaly detection or other relevant fields. The terms “about” or “substantially”, “similar to”, “similar”, “approximately” are used to indicate a deviation from the stated property or numerical value within which the deviation has little to no influence of the corresponding function, property, or attribute of the structure being described. In an illustrated example, where a dimensional parameter is described as “substantially equal” to another dimensional parameter, the term “substantially” is intended to reflect that the two dimensions being compared can be unequal within a tolerable limit, such as a fabrication tolerance. In the present disclosure, “ranges” refers to a range of values between the two stated extents and/or including one of the two stated extents.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method comprising:
training a convolutional neural network to identify matches between portions of check images, wherein the convolutional neural network comprises a first plurality of layers, and the first plurality of layers comprises a convolutional layer, a rectified linear unit layer, a pooling layers, and a flattening layer, and wherein the training comprises:
generating a first feature vector from a first portion of a first check image at least in part by passing the first portion through the first plurality of layers;
generating a second feature vector from a second portion of a second check image at least in part by passing the first portion through the first plurality of layers; and
calculating a first similarity value of the first feature vector to the second feature vector with a transformer of the convolutional neural network using a second plurality of layers to compare the first feature vector to the second feature vector;
using outputs of the convolutional neural network as inputs to train a machine-learning model with a supervised learning algorithm and a training data set, a training data set example of the training data set comprising corresponding check-in-clearing data, two or more indicators based at least in part on the outputs of the convolutional neural network that individually indicate that a first respective portion of an example check image matches a second respective portion of at least one historical check image, and a label indicating whether the training data set example is associated with fraud;
receiving, via one or more networks by a computing device, check-in-clearing data corresponding to a pending check transaction from a check clearing process executed by a computer system, the check-in-clearing data comprising an image of a check;
identifying, by the computing device from account data corresponding to the pending check transaction received from the computer system executing the check clearing process, a set of one or more historical check images corresponding to one or more historical check transactions;
inputting, by the computing device, a plurality of image pairs to the convolutional neural network, each image pair comprising one of a plurality of images representing different portions of the image of the check and a corresponding portion of one of the set of one or more historical check images, wherein the convolutional neural network outputs a second similarity value based at least in part on generating feature vectors from passing the plurality of images pairs through the first plurality of layers and passing the feature vectors through the second plurality of layers;
determining, by the computing device and based at least in part on the second similarity value output by the convolutional neural network, a plurality of image matches between the plurality of images representing the different portions of the image of the check and the corresponding portions of the set of one or more historical check images;
inputting, by the computing device to the machine-learning model as input, the check-in-clearing data, a plurality of indicators indicating the plurality of matches between the plurality of images representing the different portions of the image of the check and the corresponding portions of the set of one or more historical check images;
determining, by the computing device, that the pending check transaction is fraudulent based at least in part on output received from the machine-learning model; and
responsive to the determining that the pending check transaction is fraudulent, rejecting, by the computing device, the pending check transaction;
transmitting, by the computing device, a notification to one or more user devices of the output received from the machine-learning model, wherein the notification further causes presentation of the image of the check and requests one or more user interactions with the one or more devices confirming whether the check is fraudulent; and
receiving, by the computing device, input responsive to the one or more user interactions with the one or more devices confirming whether the check is fraudulent, and using the input to retrain and/or update the machine-learning model.

2. The computer-implemented method of claim 1, further comprising performing one or more operations comprising at least one of: rejecting the pending check transaction, transmitting a notification, transmitting an electronic message, or presenting data indicating that the pending check transaction is fraudulent.

3. The computer-implemented method of claim 1, further comprising:
obtaining check-in-clearing data instances and corresponding historical check transactions of respective accounts associated with the check-in-clearing data instances;
generating, by the computing device, the training data set based at least in part on the check-in-clearing data instances and the historical check transactions that were obtained; and
training the machine-learning model with the supervised learning algorithm and the training data set.

4. The computer-implemented method of claim 1, wherein the training data set example further comprises consortium data, the consortium data being received from a corresponding computing device associated with a consortium, the consortium data indicating at least one entity that has been determined to be associated with past fraudulent activity.

5. The computer-implemented method of claim 1, wherein the corresponding check-in-clearing data comprises a first check image, wherein the set of one or more historical check images comprises a second check image, and wherein the method further comprises:
identifying, from the first check image, a first handwriting example;
identifying, from the second check image, a second handwriting example;
comparing the first handwriting example to the second handwriting example; and
generating, by the computing device, a handwriting similarity value indicating a degree of handwriting similarity based at least in part on comparing the first handwriting example to the second handwriting example, wherein the training data set example further comprises the handwriting similarity value.

6. The computer-implemented method of claim 1, further comprising:
identifying a first handwriting example identified from a first image of a first check of the check-in-clearing data corresponding to the pending check transaction;
identifying a second handwriting example from a second image of a second check from the set of one or more historical check images; and
generating, by the computing device, a handwriting similarity value indicating a degree of handwriting similarity between the first handwriting example and the second handwriting example, wherein the handwriting similarity value is provided as part of the input to the machine-learning model.

7. The computer-implemented method of claim 6, wherein generating the handwriting similarity value comprises:
generating, using the convolutional neural network, a first feature embedding of the first handwriting example;
generating, using the convolutional neural network, a second feature embedding of the second handwriting example; and
calculating the handwriting similarity value based at least in part on the first feature embedding and the second feature embedding.

8. A computing device comprising:
one or more processors; and
one or more memories storing computer-executable instructions that, when executed by the one or more processors, causes the one or more processors of the computing device to perform operations comprising:
training a convolutional neural network to identify matches between portions of check images, wherein the convolutional neural network comprises a first plurality of layers, and the first plurality of layers comprises a convolutional layer, a rectified linear unit layer, a pooling layers, and a flattening layer, and wherein the training comprises:
generating a first feature vector from a first portion of a first check image at least in part by passing the first portion through the first plurality of layers;
generating a second feature vector from a second portion of a second check image at least in part by passing the first portion through the first plurality of layers; and
calculating a first similarity value of the first feature vector to the second feature vector with a transformer of the convolutional neural network using a second plurality of layers to compare the first feature vector to the second feature vector;
using outputs of the convolutional neural network as inputs to train a machine-learning model with a supervised learning algorithm and a training data set, a training data set example of the training data set comprising corresponding check-in-clearing data, two or more indicators based at least in part on the outputs of the convolutional neural network that individually indicate that a first respective portion of an example check image matches a second respective portion of at least one historical check image, and a label indicating whether the training data set example is associated with fraud;
receiving, via one or more networks, check-in-clearing data corresponding to a pending check transaction from a check clearing process executed by a computer system, the check-in-clearing data comprising an image of a check;
identifying, from account data corresponding to the pending check transaction received from the computer system executing the check clearing process, a set of one or more historical check images corresponding to one or more historical check transactions;
inputting a plurality of image pairs to the convolutional neural network, each image pair comprising one of a plurality of images representing different portions of the image of the check and a corresponding portion of one of the set of one or more historical check images, wherein the convolutional neural network outputs a second similarity value based at least in part on generating feature vectors from passing the plurality of images pairs through the first plurality of layers and passing the feature vectors through the second plurality of layers;
determining, based at least in part on the second similarity value output by the convolutional neural network, a plurality of image matches between the plurality of images representing the different portions of the image of the check and the corresponding portions of the set of one or more historical check images;
inputting to the machine-learning model as input, the check-in-clearing data, a plurality of indicators indicating the plurality of matches between the plurality of images representing the different portions of the image of the check and the corresponding portions of the set of one or more historical check images;
determining that the pending check transaction is fraudulent based at least in part on output received from the machine-learning model;
responsive to the determining that the pending check transaction is fraudulent, rejecting the pending check transaction;
transmitting a notification to one or more user devices of the output received from the machine-learning model, wherein the notification further causes presentation of the image of the check and requests one or more user interactions with the one or more devices confirming whether the check is fraudulent; and
receiving input responsive to the one or more user interactions with the one or more devices confirming whether the check is fraudulent, and using the input to retrain and/or update the machine-learning model.

9. The computing device of claim 8, wherein executing the computer-executable instructions further causes the one or more processors of the computing device to perform additional operations comprising at least one of: rejecting the pending check transaction, transmitting a notification, transmitting an electronic message, or presenting data indicating that the pending check transaction is fraudulent.

10. The computing device of claim 8, wherein executing the computer-executable instructions further causes the one or more processors of the computing device to perform additional operations comprising:
obtaining check-in-clearing data instances and corresponding historical check transactions of respective accounts associated with the check-in-clearing data instances;
generating the training data set based at least in part on check-in-clearing data instances and the historical check transactions obtained; and
training the machine-learning model with the supervised learning algorithm and the training data set as generated.

11. The computing device of claim 8, wherein the training data set example further comprises consortium data, the consortium data being received from a corresponding computing device associated with a consortium, the consortium data indicating at least one entity that has been determined to be associated with past fraudulent activity.

12. The computing device of claim 8, wherein the corresponding check-in-clearing data comprises a first check image, wherein the set of one or more historical check images comprises a second check image, and wherein executing the computer-executable instructions further causes the one or more processors of the computing device to perform additional operations comprising:
identifying, from the first check image, a first handwriting example;
identifying, from the second check image, a second handwriting example;
comparing the first handwriting example to the second handwriting example; and
generating a handwriting similarity value indicating a degree of handwriting similarity based at least in part on comparing the first handwriting example to the second handwriting example, wherein the training data set example further comprises the handwriting similarity value.

13. The computing device of claim 8, wherein executing the computer-executable instructions further causes the one or more processors of the computing device to perform additional operations comprising:
identifying a first handwriting example identified from a first image of a first check of the check-in-clearing data corresponding to the pending check transaction;
identifying a second handwriting example from a second image of a second check from the set of one or more historical check images; and
generating a handwriting similarity value indicating a degree of handwriting similarity between the first handwriting example and the second handwriting example, wherein the handwriting similarity value is provided as part of the input to the machine-learning model.

14. The computing device of claim 13, wherein executing the computer-executable instructions further causes the handwriting similarity value further causes the one or more processors of the computing device to perform subsequent operations comprising:
generating, using the convolutional neural network, a first feature embedding of the first handwriting example;
generating, using the convolutional neural network, a second feature embedding of the second handwriting example; and
calculating the handwriting similarity value based at least in part on the first feature embedding and the second feature embedding.

15. A non-transitory, computer-readable storage medium storing computer-executable instructions that, when executed with one or more processors of a computing device, causes the computing device to perform operations comprising:
training a convolutional neural network to identify matches between portions of check images, wherein the convolutional neural network comprises a first plurality of layers, and the first plurality of layers comprises a convolutional layer, a rectified linear unit layer, a pooling layers, and a flattening layer, and wherein the training comprises:
generating a first feature vector from a first portion of a first check image at least in part by passing the first portion through the first plurality of layers;
generating a second feature vector from a second portion of a second check image at least in part by passing the first portion through the first plurality of layers; and
calculating a first similarity value of the first feature vector to the second feature vector with a transformer of the convolutional neural network using a second plurality of layers to compare the first feature vector to the second feature vector;
using outputs of the convolutional neural network as inputs to train a machine-learning model with a supervised learning algorithm and a training data set, a training data set example of the training data set comprising corresponding check-in-clearing data, two or more indicators based at least in part on the outputs of the convolutional neural network that individually indicate that a first respective portion of an example check image matches a second respective portion of at least one historical check image, and a label indicating whether the training data set example is associated with fraud;
receiving, via one or more networks check-in-clearing data corresponding to a pending check transaction from a check clearing process executed by a computer system, the check-in-clearing data comprising an image of a check;
identifying, from account data corresponding to the pending check transaction received from the computer system executing the check clearing process, a set of one or more historical check images corresponding to one or more historical check transactions;
inputting a plurality of image pairs to the convolutional neural network, each image pair comprising one of a plurality of images representing different portions of the image of the check and a corresponding portion of one of the set of one or more historical check images, wherein the convolutional neural network outputs a second similarity value based at least in part on generating feature vectors from passing the plurality of images pairs through the first plurality of layers and passing the feature vectors through the second plurality of layers;
determining, based at least in part on the second similarity value output by the convolutional neural network, a plurality of image matches between the plurality of images representing the different portions of the image of the check and the corresponding portions of the set of one or more historical check images;
inputting to the machine-learning model as input, the check-in-clearing data, a plurality of indicators indicating the plurality of matches between the plurality of images representing the different portions of the image of the check and the corresponding portions of the set of one or more historical check images;
determining that the pending check transaction is fraudulent based at least in part on output received from the machine-learning model;
responsive to the determining that the pending check transaction is fraudulent, rejecting the pending check transaction;
transmitting a notification to one or more user devices of the output received from the machine-learning model, wherein the notification further causes presentation of the image of the check and requests one or more user interactions with the one or more devices confirming whether the check is fraudulent; and
receiving input responsive to the one or more user interactions with the one or more devices confirming whether the check is fraudulent, and using the input to retrain and/or update the machine-learning model.

16. The non-transitory, computer-readable storage medium of claim 15, wherein executing the computer-executable instructions further causes the one or more processors of the computing device to perform additional operations comprising:
obtaining check-in-clearing data instances and corresponding historical check transactions of respective accounts associated with the check-in-clearing data instances;
generating the training data set based at least in part on check-in-clearing data instances and the historical check transactions obtained; and
training the machine-learning model with the supervised learning algorithm and the training data set as generated.

17. The non-transitory, computer-readable storage medium of claim 15, wherein the training data set example further comprises consortium data, the consortium data being received from a corresponding computing device associated with a consortium, the consortium data indicating at least one entity that has been determined to be associated with past fraudulent activity.

18. The non-transitory, computer-readable storage medium of claim 15, wherein the corresponding check-in-clearing data comprises a first check image, wherein the set of one or more historical check images comprises a second check image, and wherein executing the computer-executable instructions further causes the one or more processors of the computing device to perform additional operations comprising:
identifying, from the first check image, a first handwriting example;
identifying, from the second check image, a second handwriting example;
comparing the first handwriting example to the second handwriting example; and
generating a handwriting similarity value indicating a degree of handwriting similarity based at least in part on comparing the first handwriting example to the second handwriting example, wherein the training data set example further comprises the handwriting similarity value.

19. The non-transitory, computer-readable storage medium of claim 15, wherein executing the computer-executable instructions further causes the one or more processors of the computing device to perform additional operations comprising:
identifying a first handwriting example identified from a first image of a first check of the check-in-clearing data corresponding to the pending check transaction;
identifying a second handwriting example from a second image of a second check from the set of one or more historical check images; and
generating a handwriting similarity value indicating a degree of handwriting similarity between the first handwriting example and the second handwriting example, wherein the handwriting similarity value is provided as part of the input to the machine-learning model.

20. The non-transitory, computer-readable storage medium of claim 19, wherein executing the computer-executable instructions further causes the one or more processors of the computing device to perform subsequent operations comprising:
generating, using the convolutional neural network, a first feature embedding of the first handwriting example;
generating, using the convolutional neural network, a second feature embedding of the second handwriting example; and
calculating the handwriting similarity value based at least in part on the first feature embedding and the second feature embedding.
